(19) United States
(12) Patent Application Publication
(10) Pub. No.: US 2017/0138445 A1
(43) Pub. Date: May 18, 2017

(54) ENDLESS DRIVE ARRANGEMENT WITH ACTIVE IDLER

(71) Applicant: Litens Automotive Partnership, Woodbridge (CA)

(72) Inventors: Ron Farewell, Mississauga (CA); Garreth Graves, Etobicoke (CA); Geoffrey W. Ryeland, North York (CA); Andrew M. Boyes, Aurora (CA)

(21) Appl. No.: 15/322,048

(22) PCT Filed: Jun. 29, 2015
(86) PCT No.: PCT/CA2015/050610

§ 371 Date: Dec. 23, 2016

Related U.S. Application Data
(60) Provisional application No. 62/018,175, filed on Jun. 27, 2014.
(60) Provisional application No. 62/050,479, filed on Sep. 15, 2014.

(51) Int. Cl. F16H 7/12; F02B 67/06

(52) U.S. Cl. CPC F16H 7/1281; F02B 67/06; F16H 2007/0874

(57) ABSTRACT

In an aspect, an endless drive arrangement for an engine is provided and includes a crankshaft pulley that is drivable by a crankshaft of the engine, a secondary motive device that is operable to drive a secondary motive device pulley; an endless drive member that is engaged with the crankshaft pulley and the secondary motive device pulley, wherein the endless drive arrangement is operable in a first mode in which tension in a first span of the endless drive member is lower tension than a second span of the endless drive member and in a second mode in which tension in the second span of the endless drive member is lower than tension in the first span of the endless drive member; first and second tensioners may move as needed to maintain tension in first and second spans of the belt.

### CROSS-REFERENCE TO RELATED APPLICATIONS

This application claims the benefit of U.S. Provisional Patent Application No. 62/018,175 filed Jun. 27, 2014, and U.S. Provisional Patent Application No. 62/050,479 filed Sep. 15, 2014, the contents of both of which are incorporated herein in their entirety.

### FIELD

This disclosure relates generally to the art of endless drive arrangements and more particularly to tensioner systems for vehicular front engine accessory drive arrangements.

### BACKGROUND

Vehicular engines typically employ a front engine accessory drive to transfer power to one or more accessories, such as an alternator, an air conditioner compressor, a water pump and various other accessories. Many different types of tensioner have been proposed throughout the history of internal combustion engines so as to maintain tension in the belt that is used to transfer the power to the accessories. Some tensioners are configured to impart a very high belt tension on the belt in order to ensure that, in all the modes of operation of the engine and accessories, a situation does not occur where the belt slips on one or more of the pulleys that it is engaged with, particularly in situations in which the engine is boosted or started by a secondary motive device. Under normal driving conditions, the rotation of the crankshaft causes one part of the belt to be relatively tight, and one part of the belt to be relatively slack. When the secondary motive device drives the belt to boost or start the engine, what is normally the slack side of the belt becomes the tight side, and what is normally the tight side of the belt becomes the slack side. In order to ensure that the side that becomes slack does not drop to zero tension the tensioner must act very quickly in order to drive the tension up sufficiently on the other side of the belt so that the belt tension throughout the belt remains positive, in order to reduce the likelihood of belt slip. Such a quick-acting tensioner can be difficult to manufacture and can drive the belt tension overall to a relatively high value, which can impact the life of the belt. It would be advantageous to be able to provide such a tensioning system relatively simply.

### SUMMARY

In an aspect, an endless drive arrangement for an engine is provided and includes a crankshaft pulley that is drivable by a crankshaft of the engine, a secondary motive device that is operable to drive a secondary motive device pulley; an endless drive member that is engaged with the crankshaft pulley and the secondary motive device pulley, wherein the endless drive arrangement is operable in a first mode in which tension in a first span of the endless drive member is lower tension than a second span of the endless drive member and in a second mode in which tension in the second span of the endless drive member is lower than tension in the first span of the endless drive member; a first tensioner that is engaged with the first span of the endless drive member; and a second tensioner that is engaged with the second span and includes a second tensioner biasing member, a second tensioner pulley that is rotatably supported on a second tensioner arm and that is urged by the second tensioner biasing member in a free-arm direction, wherein the second tensioner further includes a load-stop surface that is engageable by a second tensioner engagement surface to limit travel of the second tensioner pulley in a second direction that is opposite to the free-arm direction. When the endless drive arrangement is operated in the first mode, the first tensioner is movable to maintain tension in the first span and the load-stop surface on the second tensioner is engaged by the second tensioner engagement surface to hold the second tensioner stationary. When the endless drive arrangement is operated in the second mode, the second tensioner engagement surface is spaced from the load-stop surface and the second tensioner pulley is urged into engagement with the second span of the endless drive member by the second tensioner biasing member.

### BRIEF DESCRIPTION OF THE DRAWINGS

The foregoing and other aspects of the invention will be better appreciated with reference to the attached drawings, wherein:

FIG. 1 is a plan view of an endless drive arrangement on an engine in accordance with an embodiment of the disclosure, in a first mode;

FIG. 2 is plan view of the endless drive arrangement shown in FIG. 1 in a second mode;

FIG. 3 is plan view of a first tensioner from the endless drive arrangement in a first position;

FIG. 4 is a plan view of the first tensioner in a second position;

FIG. 5a is a perspective view of a second tensioner from the endless drive arrangement shown in FIG. 1;

FIG. 5b is a plan view of the second tensioner when the drive arrangement is in the second mode;

FIG. 5c is a plan view of the second tensioner when the drive arrangement is in the first mode;

FIG. 6 is a graph illustrating the response of a drive arrangement in the first and second modes in accordance with the prior art;

FIG. 7 is a graph illustrating the response of the drive arrangement shown in FIG. 1 in the first and second modes;

FIG. 8 is a comparison of a portion of the graphs in FIGS. 6 and 7;

FIGS. 9a-9c illustrate another embodiment of the second tensioner; and

FIGS. 10-12 are yet other embodiments of the second tensioner.

### DETAILED DESCRIPTION OF EXAMPLE EMBODIMENTS

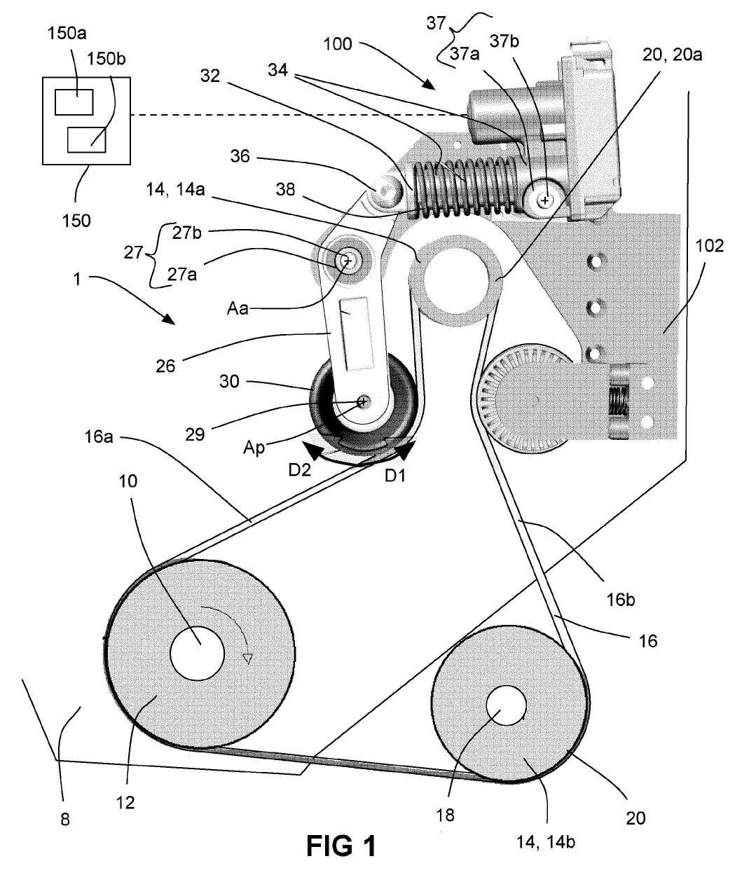

FIG. 1 shows an endless drive arrangement 1 for an engine, shown at 8. In embodiments wherein the engine 8 is mounted in a vehicle, the endless drive arrangement 1 may be a front engine accessory drive. The engine 8 includes a crankshaft 10 that has a crankshaft pulley 12 mounted thereon. The crankshaft pulley 12 is drivable by the crankshaft 10 of the engine 8 and itself drives one or more vehicle accessories 14 via an endless drive member, such as a belt 16. For convenience the endless drive member will be referred to as a belt, however it will be understood that it could be any other type of endless drive member. The accessories 14 may include a motor-generator unit (MGU) 14a, an air conditioning compressor 14b, a water pump (not shown), a power steering pump (not shown) and/or any other suitable accessory.

In FIG. 1, two accessories 14 are shown, however there could be more or fewer accessories. Each of the driven accessories has a shaft 18 and a pulley 20.

As can be seen in FIG. 1, the belt 16 is engaged with the crankshaft pulley 12 and the MGU pulley shown at 20a (and the other accessory pulleys 20). The endless drive arrangement 1 may be operated in two modes, namely a first mode, which may also be referred to as a ‘normal’ mode, and a second mode. In the first mode, the engine 8 drives the belt 16, and drives the pulleys 20 of the accessories 14; the MGU 14a does not drive the belt 16. In the first mode, the MGU 14a, if needed to act as an alternator may provide a load that is driven by the belt 16. In the second mode, the MGU 14a is operable to drive the MGU pulley 20 and drives the belt 16 via the MGU pulley (shown at 20a). The second mode may be a ‘boost’ mode, a BAS (Belt-Alternator Start), or ISAF (Idle/Stop Accessory Function) mode. If the second mode is a boost mode, the belt 16 is driven by both the MGU 14a and the engine 8. If the second mode is a BAS mode, the MGU 14a drives the belt 16 in order to cause rotation of the crankshaft 10, and thereby start the engine 8. If the second mode is an ISAF mode, the MGU 14a drives the belt 16 in spite of the engine 8 being off, in order to drive other accessories, such as the air conditioning compressor 14b, so that the accessories can continue to function even when the engine 8 is off.

When the endless drive arrangement 1 is operated in the first mode, it will be understood that tension in a first span 16a of the belt 16 is lower than tension in a second span 16b of the belt 16, due to the driving force exerted on the belt 16 by the crankshaft pulley 12 and the drag forces exerted on the belt 16 by the accessory pulleys 20. By contrast, when the endless drive arrangement 1 is operated in the second mode, tension in the second span 16b of the belt 16 is lower than tension in the first span 16a of the belt 16, due to the driving force exerted on the belt 16 by the MGU pulley 20a and the drag forces exerted on the belt 16 by the accessory pulleys 20.

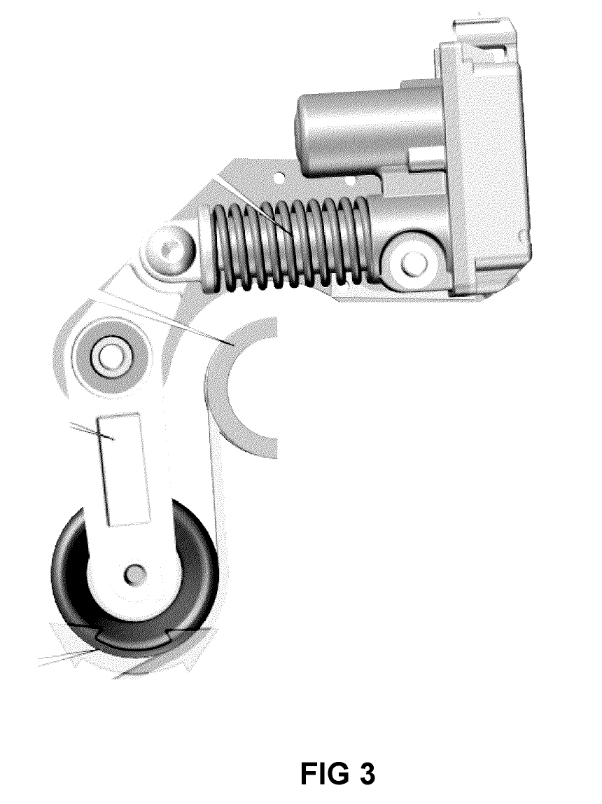

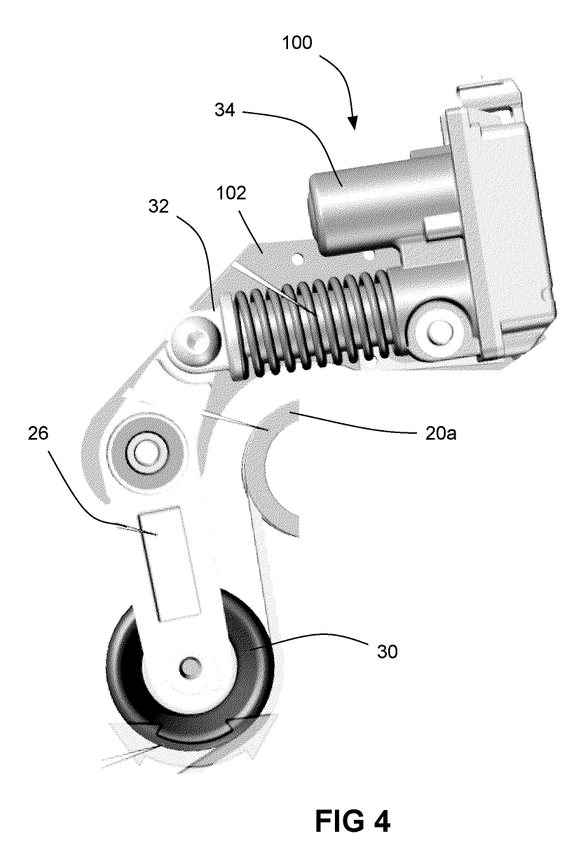

A first tensioner 24 is engaged with the first span 16a and is movable between a first position (FIG. 3) and a second position (FIG. 4) over a first range of tensions in the first span 16a of the belt 16. The first tensioner 24 may be any suitable type of tensioner, such as, the tensioner shown in PCT publication WO2013159181A1, the contents of which are incorporated fully herein by reference.

The first tensioner 24 includes a tensioner strut 100, a tensioner arm 26 that is pivotally mounted to a stationary structure (e.g. to a tensioner base 102 that is itself fixedly mounted to the block of the engine 8) via a pivot connection 27 for pivoting movement about a first tensioner arm pivot axis Aa. The pivot connection 27 may be provided by a ring 27a on the arm 26 that connects to a pivot shaft 27b on the stationary structure. A pulley 30 is rotatably mounted to the tensioner arm 26 via a second pivot shaft 29 for rotation about a pulley axis Ap that is offset from the arm pivot axis Aa. The tensioner arm 26 may have any suitable shape.

The tensioner strut 100 is mounted between the tensioner arm 26 and the stationary structure, (e.g. the base 102). The tensioner strut 100 includes an extensible member 32 slidably disposed in a housing 34. The extensible member 32 is pivotally mounted to the tensioner arm 26 via a pivot connection 36 (e.g. a pin joint). The housing 34 is pivotally mounted to the stationary member (e.g. the base 102) via a pivot connection 37 formed by a ring 37a on the housing 34 that mounts to a pivot shaft 37b on the stationary member (e.g. the engine 8).

A tensioner arm biasing member 38 such as a helical coil spring is disposed between the extensible member 32 and housing 34 so as to urge the extensible member 32 out of the housing 34 and push the tensioner arm 26 towards the belt 16. Thus, the tensioner arm 26 moves along an arcuate path between a ‘free arm’ position, which is an end of travel location along the path that the tensioner arm 26 is capable of reaching in the direction urged by the biasing member 38 (and which represents a first end (a low end) of the first range of tensions in the first span 16a of the belt 16), and a ‘load-stop’ position which is the position of farthest travel that would occur due to force exerted by the belt 16 on the pulley 30 (away from the free-arm position (and which represents a second end (a high end or peak) of the first range of tensions in the first span 16a of the belt 16). The directions of travel of the tensioner arm 26 may be referred to as the ‘free arm’ direction when traveling towards the free arm position (shown by arrow D1 in FIG. 1) and the ‘load-stop’ direction when traveling towards the load-stop position, and therefore away from the free-arm position, (shown by arrow D2 in FIG. 1). The free-arm and load-stop positions may be defined by pairs of mechanical limit surfaces (not identified in the figures) that are engaged with one another at selected points in the travel of the tensioner arm 26.

Any suitable damping structure may be provided to dampen the movement of the arm. The damping structure may include a bushing similar to that which is shown in U.S. Pat. No. 8,591,258, the contents of which are incorporated herein by reference in their entirety. Such a damping structure would be referred to as constant damping (i.e. damping that is not proportional to the speed of movement of the arm 26) and would be present at the pivot connection 27.

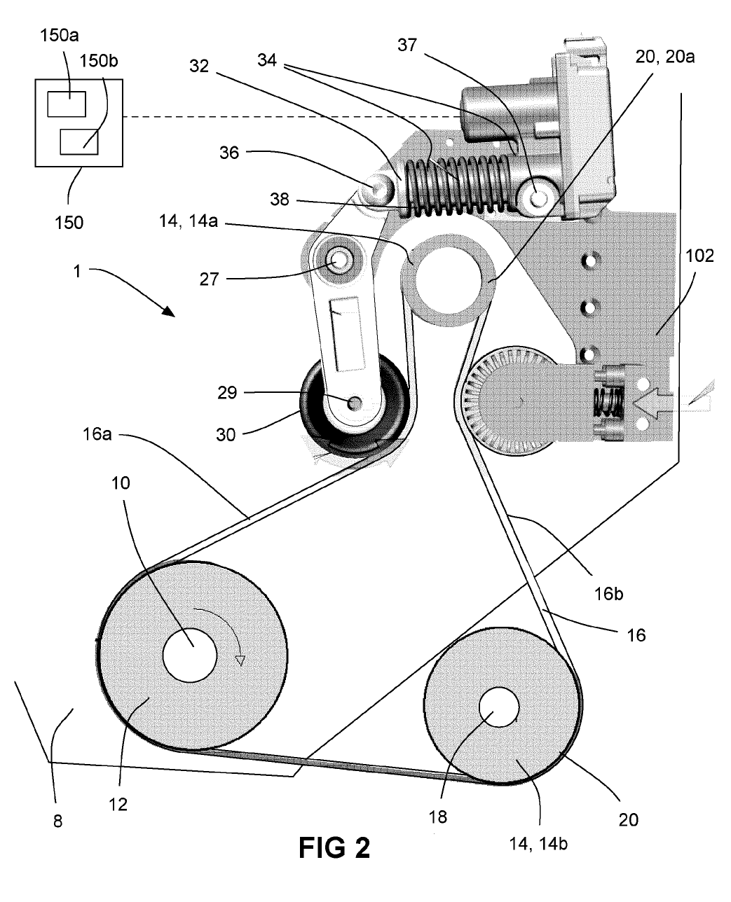

Referring to FIGS. 1 and 2, the strut 100 may further include an actuator 64 that is controlled by a control system 150. The control system 150 may include a single controller, as shown in FIGS. 1 and 2, or it may be made up of a plurality of controllers in a network. The control system 150 may be provided as part of a package that includes the strut 100, the arm 26, the pulley 30, or alternatively, the control system 150 may be a unit that is provided separate from the other aforementioned components. The control system 150 may, for example, be a vehicle engine control unit that is provided by a business entity that is separate from the business entity that provides the other components. In such a case, the tensioner 24 may be said to not include the control system 150. Alternatively, the tensioner 24 may be provided with a control system 150.

The control system 150 includes at least a processor 150a and a memory 150b. The control system 150 may be programmed as suitable to send signals (e.g. electrical signals) to the actuator 64 to operate the tensioner 24 in a high tension mode (which would be used when the endless drive arrangement is operated (e.g. by the control system 150) in the second mode of operation, shown in FIG. 2) and in a low tension mode (which would be used when the endless drive arrangement is operated (e.g. by the control system 150) in the first mode of operation, shown in FIG. 1). In the low tension mode of operation, the first tensioner 24 may be movable between the first and second positions based on the force of the biasing member 38 and the belt tension in span 16a. In the high tension mode of operation (FIG. 2) the first tensioner may be operated by the control system to maintain a relatively higher tension in span 16a in order to ensure that sufficient tension is present throughout the length of the belt 16.

While the first tensioner 24 is shown as being controllable (via control system 150) to increase tension in the belt 16, it will be noted that the first tensioner 24 could alternatively be a passive tensioner that is simply moved by a biasing member such as biasing member 38 and that does not include a control system.

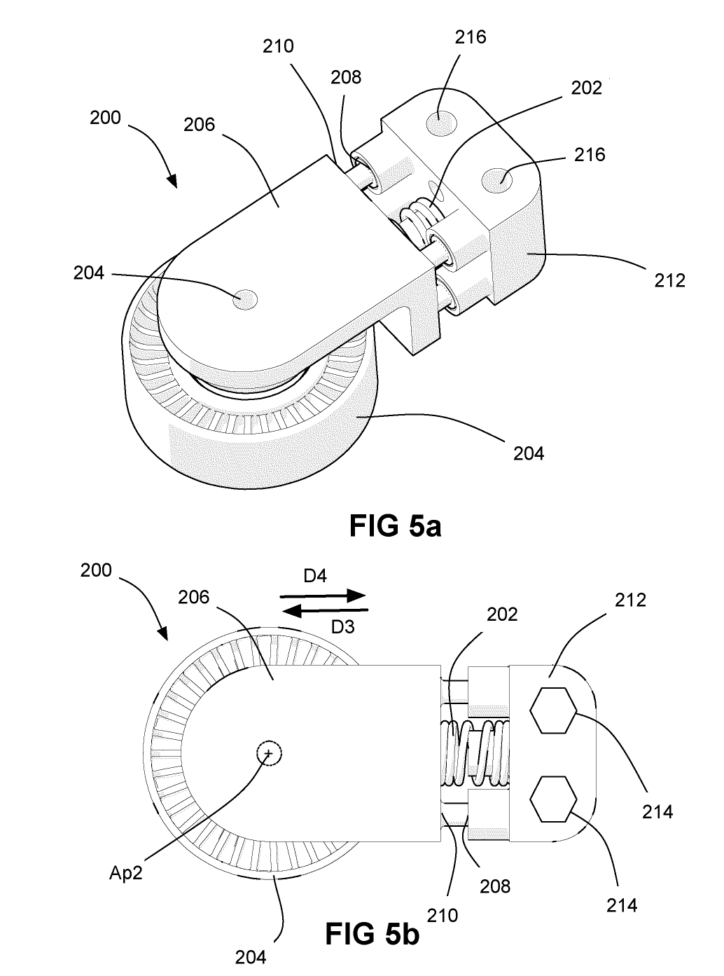

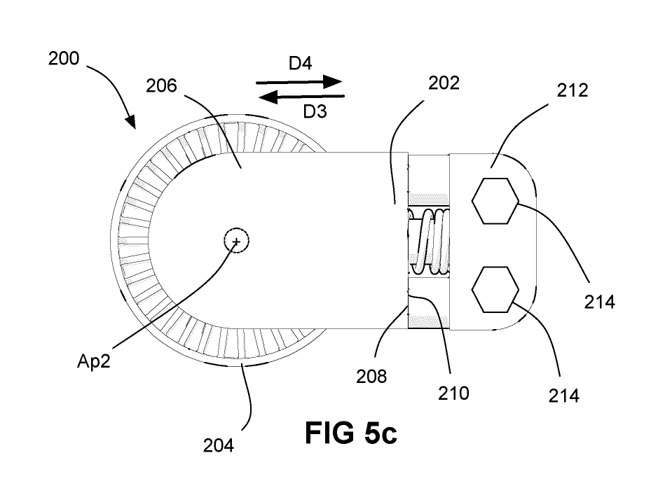

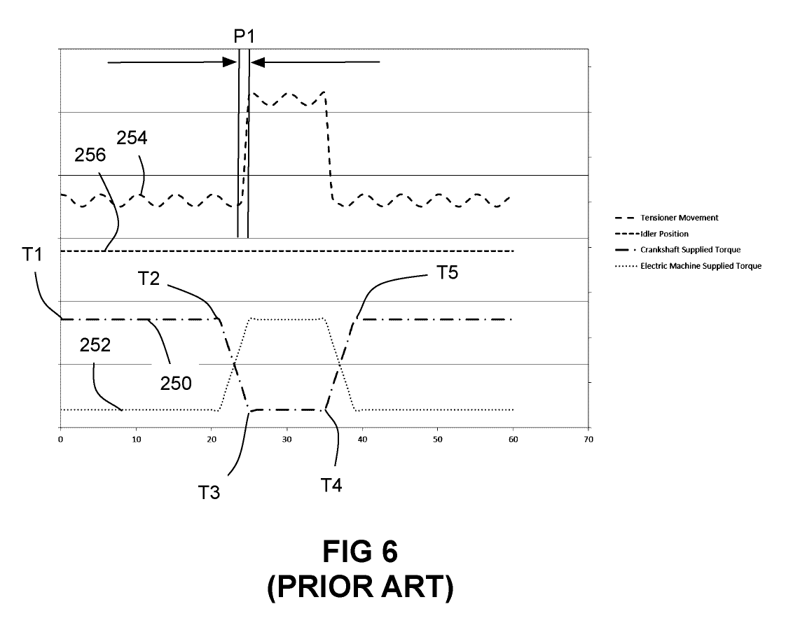

Referring to FIG. 1, the second tensioner is shown at 200. The second tensioner 200 is engaged with the second span 16b of the belt 16, and, with reference to FIGS. 5a and 5b, includes a second tensioner biasing member 202, a second tensioner pulley 204 that is rotatably supported on a second tensioner arm 206 for rotation about a second tensioner pulley axis AP2 and that is urged by the second tensioner biasing member 202 in a free-arm direction (shown by arrow D3). The second tensioner 200 further includes a load-stop surface 208 that is engageable by a second tensioner engagement surface 210 to limit travel of the second tensioner pulley 204 in a second direction (shown by arrow D4) that is opposite to the free-arm direction.

The limit surface 208 may be provided anywhere suitable such as on a second tensioner base 212 that is fixedly mounted to the overall tensioner base 102 via fasteners 214 through apertures 216 in the base 212.

When the endless drive arrangement 1 (FIG. 1) is operated in the first mode, the first tensioner 24 is movable to maintain tension in the first span 16a, and the load-stop surface 208 (FIG. 5c) on the base 212 is engaged by the second tensioner engagement surface 210 to hold the second tensioner 200 stationary. It will be noted that, ‘stationary’ in this sense refers to movement of the arm 206. The tensioner pulley 204 will be rotating by virtue of engagement with the moving belt 16, but the tensioner 200 is nonetheless said to be stationary when the drive arrangement 1 is in the first mode.

When the endless drive arrangement 1 is operated in the second mode, the second tensioner engagement surface 210 is spaced from the load-stop surface 208 (FIG. 5b) and the second tensioner pulley 204 is urged into engagement with the second span 16b of the endless drive member 16 by the second tensioner biasing member 202.

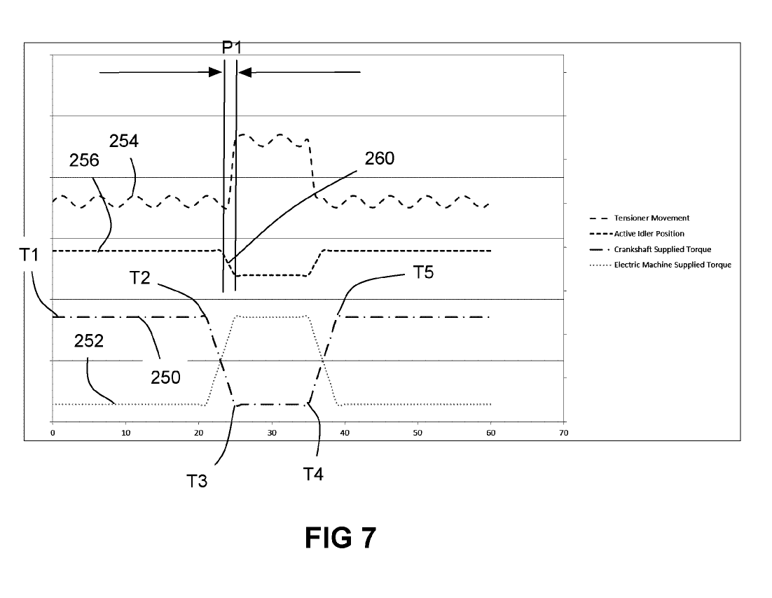

Reference is made to FIG. 6, which is a graph illustrating the operation of the endless drive arrangement 1 in the two modes of operation and the response of a tensioner of the prior art, wherein a first tensioner is engaged with the first span 16a and a fixed idler is engaged with the second span 16b. The drive arrangement is operated in the first mode between time points T1 and T2. At point T2 the drive arrangement is switched over to the second mode of operation which it reaches at time point T3. At time point T4, the drive arrangement is switched back to the first mode of operation, which it reaches at time point T5. As can be seen, when switching to the second mode, the first tensioner of the prior art must drive the belt tension in the belt 16 within a relatively short period of time shown at P1, in order to prevent the tension in the belt 16 from reaching zero in the second span 16b. In the graph in FIG. 6, the curves shown at 250 and 252 represent the torques provided by the crankshaft and the MGU respectively, while the curves shown at 254 and 256 represent the positions of the tensioner according to the prior art and the fixed idler respectively, which are positioned on the first and second belt spans respectively.

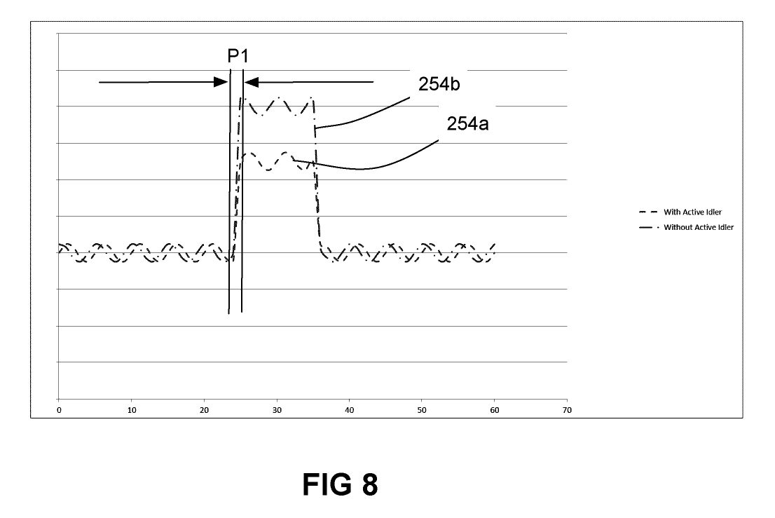

FIG. 7 illustrates the same points T1-T5, and the positions of the first tensioner 24 and the second tensioner 200. As shown in FIG. 7, when switching to the second mode of operation, there is a short period P1 in which the first tensioner 24 must move sufficiently to achieve a selected belt tension in the first belt span 16a in order to ensure that there is sufficient belt tension in the overall belt 16 (and in particular in belt span 16b). This tension is lower than is needed in the prior art system shown in FIG. 6, since the second tensioner 200 can extend outward during time period P1 sufficiently to ensure that there is some tension in the second span 16b, as shown in the graph in FIG. 7 at 260. Thus, the first tensioner 24 must move less than is needed in the system of the prior art (that incorporates a fixed idler on the second span 16b), since the tension needed in the first span 16a is lower when in the second mode.

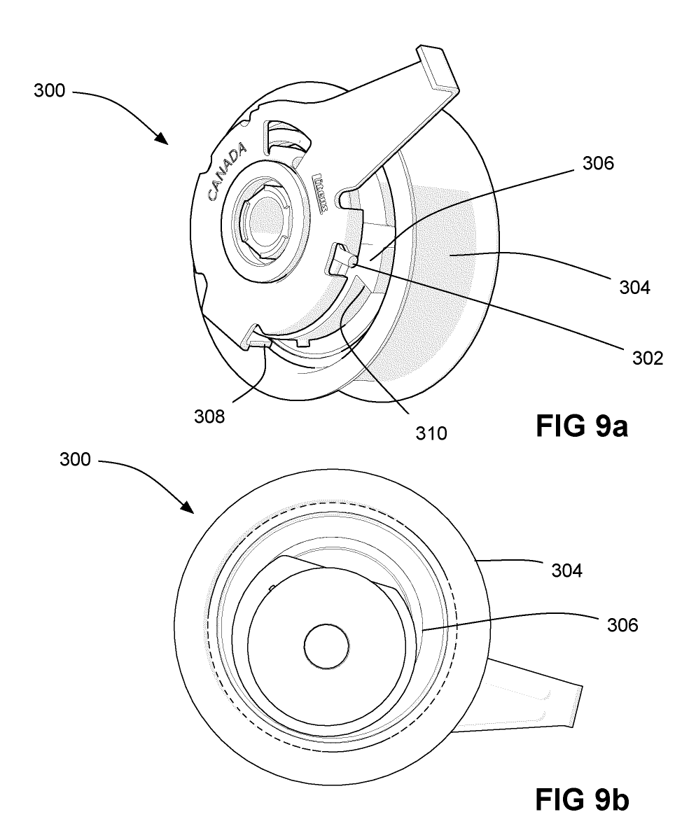

Because the first and second tensioners 24 and 200 both move during a transition from the first mode to the second mode, the amount of movement that is needed in the first tensioner is less than that which is required of the first tensioner in a drive arrangement with a fixed idler on the second span (FIG. 6). FIG. 8 shows a comparison of the curves 254 (now shown as curves 254a and 254b) to show that there is less movement required of the tensioner 24 than the first tensioner in the prior art drive arrangement during period P1.

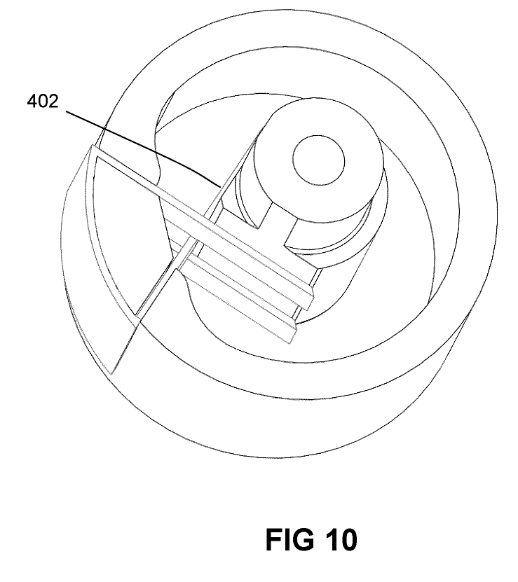

The second tensioner arm 206 (FIGS. 5a-5c) moves linearly in the free-arm and load-stop directions. FIGS. 9a-9c show another embodiment of the second tensioner (shown at 300) in which the second tensioner arm shown at 306 has a pulley 304 thereon and is biased by second tensioner biasing member 302 in a free arm direction wherein the biasing member 302 is a torsion spring. The second arm 306 moves about a pivot axis.

Pivoting movement may reduce friction. It is beneficial to provide any of the second tensioners described herein with relatively low damping (i.e. frictional or other resistance to movement) particularly in the free-arm direction so as to provide them with fast extension during transition to the second mode of operation. The load-stop surface and the engagement surface are shown at 308 and 310.

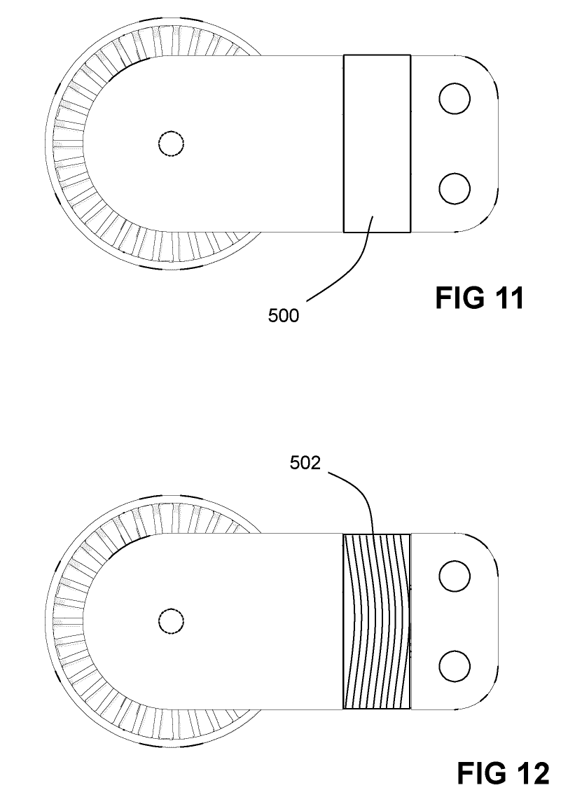

FIG. 10 is another embodiment, in which a leaf spring 402 is used, shown at 400.

FIG. 11 shows a rubber or closed cell foam member 500 to bias the second tensioner. FIG. 12 shows a set of wave washers 502 to bias the second tensioner.

The MGU 14a is an example of a secondary motive device that drives the belt 16 when the endless drive arrangement 1 is operated in the second mode. It will be understood, however, that other types of secondary motive device may be used in the endless drive arrangement 1 instead of the MGU 14a. For example, a standard alternator may be provided for charging the battery of the vehicle instead of the MGU 14a, and a separate electric drive motor (not shown) may be provided as the secondary motive device.

While the description contained herein constitutes a plurality of embodiments of the present invention, it will be appreciated that the present invention is susceptible to further modification and change without departing from the fair meaning of the accompanying claims.

1. An endless drive arrangement for an engine, comprising:
a crankshaft pulley that is drivable by a crankshaft of the engine;
a secondary motive device that is operable to drive a secondary motive device pulley;
an endless drive member that is engaged with the crankshaft pulley and the secondary motive device pulley, wherein the endless drive arrangement is operable in a first mode in which tension in a first span of the endless drive member is lower tension than a second span of the endless drive member and in a second mode in which tension in the second span of the endless drive member is lower than tension in the first span of the endless drive member;
a first tensioner that is engaged with the first span of the endless drive member; and
a second tensioner that is engaged with the second span and includes a second tensioner biasing member, a second tensioner pulley that is rotatably supported on a second tensioner arm and that is urged by the second tensioner biasing member in a free-arm direction, wherein the second tensioner further includes a load-stop surface that is engageable by a second tensioner engagement surface to limit travel of the second tensioner pulley in a second direction that is opposite to the free-arm direction,
wherein, when the endless drive arrangement is operated in the first mode, the first tensioner is movable to maintain tension in the first span and the load-stop surface on the second tensioner is engaged by the second tensioner engagement surface to hold the second tensioner stationary, and
wherein, when the endless drive arrangement is operated in the second mode, the second tensioner engagement surface is spaced from the load-stop surface and the second tensioner pulley is urged into engagement with the second span of the endless drive member by the second tensioner biasing member.

2. An endless drive arrangement as claimed in claim 1, wherein the second tensioner engagement surface is connected to the second tensioner arm.

3. An endless drive arrangement as claimed in claim 1, wherein in the first mode, the crankshaft pulley drives the endless drive member and the secondary motive device pulley does not drive the endless drive member, and in the second mode, the secondary motive device pulley drives the endless drive member.

4. An endless drive arrangement as claimed in claim 1, wherein the second tensioner biasing member is a helical compression spring.

5. An endless drive arrangement as claimed in claim 1, wherein the second tensioner biasing member is a helical compression spring is a leaf spring.

6. An endless drive arrangement as claimed in claim 1, wherein the second tensioner pulley is supported on a second tensioner arm that is pivotable about a second tensioner arm pivot axis.
